(19) United States
(12) Patent Application Publication
(10) Pub. No.: US 2011/0089833 A1
(43) Pub. Date: Apr. 21, 2011

(54) FLUORESCENT LAMP BASE CAP AND METHOD OF ADJUSTING A BASE CAP OF A FLUORESCENT LAMP

(76) Inventor: Franciscus Adrianus Steur, Apeldoorn (NL)

(21) Appl. No.: 12/734,503

(22) PCT Filed: Nov. 5, 2007
(86) PCT No.: PCT/NL2007/050540

§ 371 Date: Nov. 22, 2010

(51) Int. Cl. H01K 1/62

(52) U.S. Cl. 315/71

(57) ABSTRACT

Fluorescent lamp base cap, provided with a fluorescent lamp circuit for driving a fluorescent lamp when the lamp is connected to the base cap, two input electrodes to connect the circuit to the mains power system when the base cap is connected with the mains power system, a feeding line for feeding the fluorescent lamp circuit, and at least one output electrode for connecting the lamp with the fluorescent lamp circuit, wherein a resistor is arranged in parallel to the feeding line. Preferably, the resistor is connected to the two input electrodes, in parallel with the fluorescent lamp circuit.

The invention relates to a fluorescent lamp base cap.

The invention also relates to a method of adjusting a base cap of a fluorescent lamp.

Every electrical load has impedance (Z). The impedance of a load is the sum of its resistance (R) and its reactance (X). A purely resistive load, such as a heating element or an incandescent lamp, has only resistance and no reactance whereas a purely reactive load, such as a capacitor or an inductor, has only reactance and no resistance. A load with complex impedance is a load that has both resistance and reactance.

The alternating current (AC) mains power supplied by electricity utility companies can for example be a 50 Hz, 230V RMS sinusoidal wave. One cycle of a sinusoidal wave is 360 degrees. When AC power is supplied to a complex impedance load, the reactive part of the load induces a phase shift between the current wave and voltage wave of the supplied power. The amount of phase shift that occurs is a measure of the power factor of that load.

Power factor is defined as the cosine of the phase angle between the current and voltage waves, which is a dimensionless number between 1 and 0. When the power factor is 1, the current wave and voltage waves are perfectly in step and all the energy supplied is consumed by the load. The power factor of purely resistive loads is equal to 1. When the power factor of a load is less than one, the current and voltage waves are out of step and only a portion of the energy supplied is consumed by the load, the rest being cyclically absorbed and reflected back at the frequency of the AC supply. A purely inductive or capacitive load results in a phase shift of positive or negative 90 degrees and a power factor of 0. Purely inductive or capacitive loads therefore on average consume no power, but merely cyclically absorb and reflect power. The closer the power factor is to 0, the less real power is available in the circuit to do work.

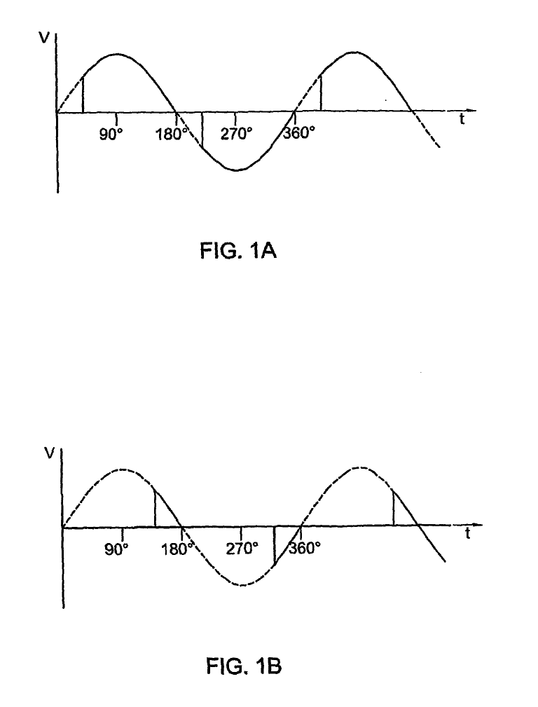

Circuits for dimming incandescent lamps are known. By varying the average power supplied to an incandescent lamp it is possible to vary the intensity of the light output. Variable autotransformers, which vary the amplitude of the mains power by using variable winding ratio transformers, have been used for dimming incandescent lamps but are bulky and expensive. Thyristor dimmers were introduced to overcome this difficulty. For lower powered applications, such as home lighting, a form of thyristor known as a triac is used. A triac can conduct in both directions and is triggered by a Resistive-Capacitive (RC) time constant circuit. By varying the value of the resistor in the RC circuit, the point at which the triac is fired is varied, thereby varying the output of the triac and implementing a dimming function. FIGS. 1A and 1B show the output voltage of a triac dimmer at two different dimming levels. The method of dimming using triac thyristors is known as phase-cut dimming.

The magnitude of the reactance of a capacitor or an inductor is a function of the frequency of the AC power supplied to it. However, the frequency of the AC power is only a single value when the AC voltage supply is a pure sinusoidal wave. In the case of phase-cut dimming, the resultant waveform is no longer sinusoidal in shape, but includes harmonics and/or noise that tend to affect the reactance of a load. Whereas incandescent lamps are purely resistive loads, fluorescent lamps include a substantial capacitive reactance. They therefore induce a phase shift between the incoming AC voltage and the incoming AC current that reduces the available real power in the circuit. Phase-cut dimmers are generally not suitable for dimming fluorescent lamps because the harmonics and/or noise on the resultant waveform increase the reactance of the fluorescent lamps which leads to a greater phase shift and resultant loss of available real power. This manifests itself in mild to severe flickering of the lamp.

Various attempts have been made to provide dimmable fluorescent lamps, for example by providing controllable switching means that can adjust the light intensity by changing the frequency of the AC voltage supplied to the fluorescent lamp. However, these lamps require expensive dedicated circuitry, as well as an additional port for controlling the switching frequency. It would be an advantage if fluorescent lamps, especially low-powered compact fluorescent lamps (CFLs), could be dimmed using standard triac phase-cut dimmers.

It is an object of the invention to enable fluorescent lamps to be dimmed using standard phase-cut dimmers with preferably less flickering than in case of conventional fluorescent lamp base caps using standard phase-cut dimmers.

In a first aspect of the invention, a fluorescent lamp base cap is provided, that is provided with a fluorescent lamp circuit for driving a fluorescent lamp when the lamp is connected to the base cap, two input electrodes to connect the circuit to the mains power system when the base cap is connected with the mains power system, a feeding line for feeding the fluorescent lamp circuit, and at least one output electrode for connecting the lamp with the fluorescent lamp circuit, wherein a resistor is arranged in parallel to the feeding line.

For example, in this way there may be provided means for increasing the ability of a fluorescent lamp to be dimmed using a standard dimmer, which can be readily applied, since every lamp at its base comprises of a connecting terminal, e.g. input electrodes, allowing power to flow into the device. This terminal conventionally allows for mains Live and Neutral to pass into the device isolated by insulation resin between two terminals. This conventional insulation resin conventionally consist of a non conductive material, while a feature of an embodiment of the invention is to make this non conductive material a resistor, comprising of at least one resistor connected in parallel between input terminals of a fluorescent lamp circuit to thereby improve the power factor of the fluorescent lamp circuit. Tests have shown that this solves the problem of flickering of the fluorescent lamp.

Further embodiments provide for the standard dimmer to be a triac phase-cut dimmer.

Further embodiments provide for the electronic as well as mechanical circuit means to include a capacitor circuit fitted into the base terminal cap allowing for optimum space utilization allowing for a much larger capacitor to be used, facilitating dim ability with standard phase-cut dimmers.

In a second aspect, the invention provides for a method of adjusting a base cap of a fluorescent lamp for increasing the ability of a fluorescent lamp to be dimmed with the aid of a standard dimmer, comprising connecting at least one resistor in parallel between input electrodes of a fluorescent lamp circuit, and on the base cap of a fluorescent lamp.

This method may increase the ability of a fluorescent lamp to be dimmed using a standard dimmer, in an embodiment comprising connecting at least one resistor in parallel between input terminals of a fluorescent lamp circuit to thereby improve the power factor of the fluorescent lamp circuit. The resistor being partly inside and/or on the outside of its cap base between the Live and Neutral terminals, replacing the insulator with a resistive material.

Further features of the invention provide for the standard dimmer to be a triac phase-cut dimmer.

In clarification of the invention, these and further embodiments of the invention, and advantages thereof will be further elucidated with reference to the drawing. In the drawing:

FIG. 1A is a graph showing the voltage output waveform of a standard triac phase-cut dimmer at a moderate dimming level;

FIG. 1B is a graph showing the voltage output waveform of a standard triac phase-cut dimmer at a high dimming level;

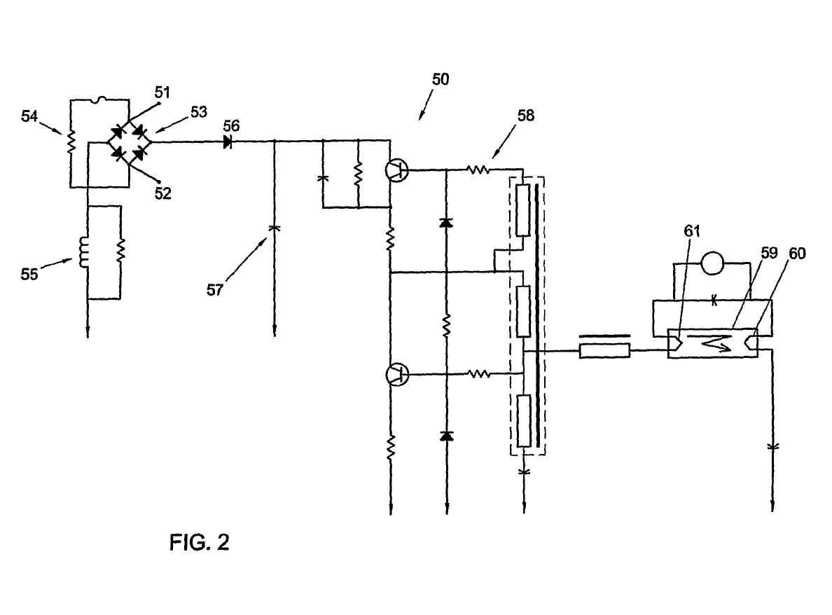

FIG. 2 is a diagram of an electronic circuit for improving the power factor of a fluorescent lamp circuit;

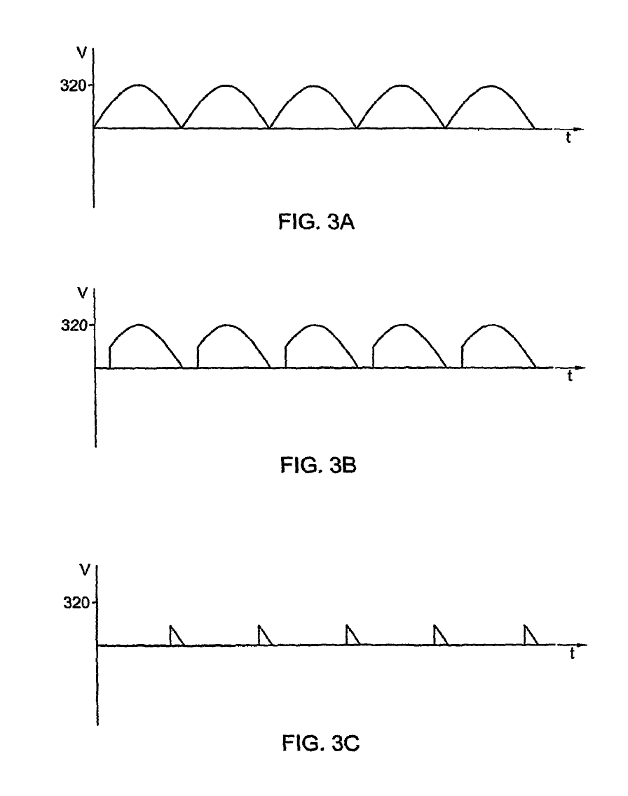

FIG. 3A is a graph showing the voltage waveform at node (20) in FIG. 2 when no dimming is applied;

FIG. 3B is a graph showing the voltage waveform at node (20) in FIG. 2 when moderate dimming is applied;

FIG. 3C is a graph showing the voltage waveform at node (20) in FIG. 2 when high dimming is applied;

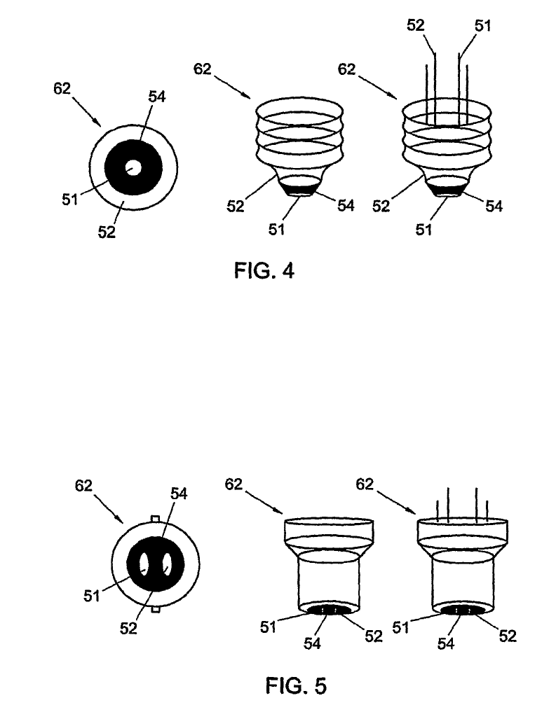

FIG. 4 are schematic drawings of a screw base cap having a resistor resin interconnected between the input electrodes; and

FIG. 5 are schematic drawings of a bayonet base cap having a resistor resin interconnected between the input electrodes.

In this description, identical or corresponding parts have identical or corresponding reference numerals. The exemplary embodiments shown should not be construed to be imitative in any manner and serve merely as illustration.

Among others, the invention comprises an electronic circuit, mechanical means and a method for increasing the ability of a fluorescent lamp to be dimmed using a standard dimmer, by improving the power factor of a fluorescent lamp circuit.

In an embodiment, the electronic circuit means 50 comprises a resistor 54 connected in parallel between the input electrodes 51, 52 of a fluorescent lamp circuit 58 (see for example FIG. 2). This resistor 54 causes the input impedance of the fluorescent lamp circuit 58 to be more resistive, improving the power factor of the circuit and therefore the amount of real power available to the circuit to do work. This resistor 54 is preferably provided on the base cap 62 (see for example FIG. 4 or 5), giving the resistor properties that it would normally not have if it were placed on a PC board. In this description “base cap” is meant to comprise the housing of the fluorescent lamp circuit that is connected to the lamp 60.

Preferably, the resistor comprises a resin like resister on the outside as well as the inside of the lamp holder, i.e. base cap, giving it certain heat dissipating properties previously impossible to attain within a conventional CFL base cap. Its location in relationship to the metal part of the base cap allows the metal part to act as a heat sink allowing fast and efficient dissipation of any heat that mite build-up, normally problematic inside the electronic enclosure of the CFL. This configuration may also allow for the component count to be minimised and/or because of better heat dissipation better utilisation of space inside an already compact enclosure can be achieved. Life expectancy of other components is thus not negatively affected by additional heat added to the circuit.

Replacing a resin insulator of a conventional lamp base cap with a resistor resin allows for a much smaller resistor value to be used without the negative heat effect within the CFL enclosure.

In an embodiment means are included for making the insulating material between the Live and Neutral input electrodes of a CFL base cap of a resistive material, preferably increasing the ability of a fluorescent lamp circuit 58 to be dimmed with a standard dimmer, in this case a phase-cut dimmer. An output of the phase-cut dimmer is for example connected to a bridge rectifier, and a sensing circuit is connected between the output of the bridge rectifier and the fluorescent lamp circuit. FIG. 3A shows the waveform of the output of the bridge rectifier, between an upper rail and a lower rail, when there is no dimming. As the dimmer starts to apply dimming, the waveform between the upper rail and lower rail starts to take the shape shown in FIG. 3B and eventually takes the shape shown in FIG. 3C when the dimmer applies high dimming levels.

An explanatory embodiment that works well in practice is shown in FIG. 2, wherein a scheme 50 is shown for operating a fluorescent lamp 59. The scheme comprises a pair of AC input terminals 51, 52 which are input to a rectifier 53 for rectifying a power signal. In parallel to the pair of AC input terminals 51, 52 a resistor 54 is connected. Further, a commonly known additional inductive circuit 55 is interconnected between a rectifier terminal and earth. The output terminal of the rectifier 53 acting as a local feeding line 62 is connected via a diode 56 to an fluorescent lamp circuit 58 for driving the lamp 59. In particular, the oscillating circuit feeds a pair of lamp input terminals 60, 61 for the fluorescent lamp 59. The local feedings line 62 is connected to earth via a capacitor 57 for storing electrical energy that is delivered by the rectifier 53.

It appears that by including resistor 54 between the pair of AC input terminals 51,52, the input impedance becomes more resistive, thereby enlarging the power factor. In another embodiment according to the invention, the resistor 54 is interconnected between the local feeding line 62 and earth.

According to the invention, the capacitance of the capacitor 57 is relatively high, preferably more than approximately 5 uF, more preferably more than approximately 10 uF. In a particular embodiment according to the invention, the capacitance of the capacitor 57 is approximately 33 uF. By using a capacitor 57 having a relatively high capacitance, a relatively large amount of electrical energy can be stored, so that the oscillating circuit 58 can operate, also in a dimmed situation when the feeding signal is modest, thereby reducing a flickering effect.

During operation of the lamp, a dimming device is arranged between AC mains and the pair of AC input terminals 51, 52 of the scheme 50. The dimming device is optionally implemented as a phase-cut dimmer chopping AC mains signals as shown in FIG. 3.

An embodiment of the invention preferably finds application in the dimming of compact fluorescent lamps (CFLs) which have a power output lower than about 25 Watts.

In a further embodiment of this invention the value of smoothing of capacitor C1 is increased to a value surpassing the smooting value of a conventional capacitor, e.g. a value of at least 10kΩ, preferably at least 20 or 25 kΩ, for example 33kΩ, for the same or like fluorescent lamp 60, wherein ripple is minimized, stabilizing the internal High Voltage DC bus by means of increasing the “reserve capacity” of the power supply that “feeds” the output switching devices.

An embodiment of the invention incorporates a phase cut dimmer directly on the mains supply rail, such that there is no distinction between the mains supply line and the control line, as opposed to conventional fluorescent lamp dimmer circuits. Control is now achieved on the mains power rail. A drawback to this type of control can be explained with reference to FIG. 3B and 3C, which show the available power for the lamp to perform work. The lack of power that is caused by applying the phase cut dimmer, and/or the noise and irregular harmonics that are caused by applying the dimmer, causes mild to severe flickering to the lamp as the reservoir capacitor does not have enough stored energy to maintain a stable output. Constant charge and discharge of the capacitor may cause erratic power to flow thru the electronic drive circuit as well as the lamp filament.

In a further embodiment of this invention a capacitor 57 is mounted in the base cap, i.e. base cap 62, of the CFL lamp. A consideration for this mechanical arrangement is as follows. Stabilizing the internal High Voltage DC bus by means of increasing the “reserve capacity” of the power supply that “feeds” the output switching devices. Increasing of the capacitor value will allow for enough power to be maintained ensuring minimization of power collapse thru the CFL circuit.

Up till now, an increase of capacitor value, generally leading to a bigger size capacitator, has proven to be problematic in conventional CFL for the following reasons. A consideration therefore is size, because one of the factors that govern CFL sales worldwide is the fiscal size of the lamp. In non dimmable application size may not be an issue, but in dimmable application an increased capacitator value has proven to be problematic as design engineers have to design around this limitation.

In an embodiment of the invention, a capacitor is mounted in the base cap of the CFL power terminal, while allowing for a normal and/or smaller sized base cap. A relatively small sized base cap provided said capacitor inside the base cap can be obtained because, as explained above, heat is dissipated in an improved manner. Normally, a problem that design engineers face is excessive heat that diminishes the life expectancy of the CFL. Therefore, in conventional CFL designs the power supply capacitor is placed as far as possible from the rest of the components inside the CFL enclosure housing, which may lead to a relatively large base cap design. Placing the supply capacitator far from the outer components acts as a protection against excessive heat transfer to and from the components causing early heat fatigue.

In a further embodiment of this invention the resistor is connected to the base cap, allowing for rapped thermal heat exchange as the base cap acts as a heat sink. Taking heat away from the primary area efficiently increases the life expectancy of the lamp.

The invention therefore provides means for increasing the ability of fluorescent lamps to be dimmed using standard dimmers, such as phase-cut dimmers, by improving the power factor of a fluorescent lamp circuit and by optionally increasing the ballast reactance of the fluorescent lamp circuit when dimming is detected. Fluorescent lamps having ballast circuits that include the electronic circuit means of the invention can be retrofitted into existing lighting networks and dimmed using existing triac phase-cut dimmers which were previously intended only for dimming incandescent lamps. The fluorescent lamp circuit of the invention, including the capacitator, can be included in the ballast circuit built into the base of compact fluorescent lamps (“CFLs”), in which case no additional hardware other than the compact fluorescent lamp itself is required. The invention provides a simple and cost-effective solution to alleviate the problems in using triac phase-cut dimmers to dim fluorescent lamps.

As said, in an embodiment, the standard dimmer is a triac phase-cut dimmer. In an embodiment, the resistor may be a resistive resin material and/or has a resistance of approximately 22 kilo-Ohms, or at least between 20 and 100 kilo-Ohms.

With an embodiment of the invention, a method of increasing the ability of a fluorescent lamp to be dimmed can be achieved, using a standard dimmer, comprising connecting at least one resistor in parallel between input terminals base cap of a fluorescent lamp circuit to thereby improve the power factor of the fluorescent lamp circuit. The standard dimmer may be a triac phase-cut dimmer. Electronic circuit means may be provided for increasing the ability of fluorescent lamps to be dimmed using standard dimmers, such as phase-cut dimmers. A control means for increasing the ability for compact fluorescent lamps (CFL) to be dimmed incorporating a resistive load across the mains terminals may generate excessive heat inside the enclosure of the CFL. A further embodiment therefore incorporates the resistive load being on the outside of the enclosure across the Neutral and Live terminals eliminating the problem of excessive heat build-up inside the enclosure. Also the cap itself may facilitate efficient removal of heat since the metal cap is connected to the resistive load across the Live and Neutral terminals of the CFL base cap. A further advantage of this arrangement can therefore be the transfer of heat across the metal base cap into the lamp holder facilitating heat dissipation. It will be appreciated that FIGS. 2, 4 and 5 are merely illustrative of some of the embodiments of the invention, and it will be apparent to a person skilled in the art that other embodiments of the invention may be devised which nevertheless fall within the scope of the appended claims.

It shall be obvious that the invention is not limited in any way to the embodiments that are represented in the description and the drawings. Many variations and combinations are possible within the framework of the invention as outlined by the claims. Combinations of one or more aspects of the embodiments or combinations of different embodiments are possible within the framework of the invention. All comparable variations are understood to fall within the framework of the invention as outlined by the claims.

1. Fluorescent lamp base cap, provided with a fluorescent lamp circuit for driving a fluorescent lamp when the lamp is connected to the base cap, two input electrodes to connect the circuit to the mains power system when the base cap is connected with the mains power system, a feeding line for feeding the fluorescent lamp circuit, and at least one output electrode for connecting the lamp with the fluorescent lamp circuit, wherein a resistor is arranged in parallel to the feeding line.

2. Base cap according to claim 1, wherein the resistor is interconnected between the two input electrodes.

3. Base cap according to claim 1, wherein the input electrodes and the resistor are provided at the outer surface of the base cap.

4. Base cap according to claim 1, wherein the base cap is arranged to be connected to a standard incandescent light fixture, and the base cap is arranged so that the input electrodes make a direct connection with the mains power system while said base cap is connected to said fixture.

5. Base cap according to claim 1, wherein the resistor comprises a resin that is arranged between the input electrodes, at least partly on the outer surface of the base cap.

6. Base cap according to claim 1, wherein the resistor is arranged at least partly on the inside as well as on the outside of the base cap.

7. Base cap according to claim 1, wherein the resistance of said resistor is substantially between approximately 20 and approximately 100 kΩ.

8. Base cap according to claim 1, wherein the fluorescent lamp circuit is provided with a capacitator for evening out rippling and/or sinusoids of a voltage waveform, wherein the capacitator is arranged within the base cap.

9. Base cap according to claim 8, wherein the capacitator has a value of at least approximately 10 μF.

10. Base cap according to claim 8, wherein the capacitator is arranged in parallel with respect to the feeding line.

11. Base cap according to claim 1, wherein a fluorescent lamp is provided in the base cap.

12. Base cap according to claim 9, wherein the lamp comprises a CFL lamp, and the fluorescent lamp circuit comprises a circuit for a CFL lamp.

13. Electronic circuit, comprising the base cap according to claim 1, and a dimmer for dimming a fluorescent lamp that when it is connected to the base cap, wherein a standard dimmer is connected between the power mains and the fluorescent lamp circuit for driving a fluorescent lamp.

14. Circuit according to claim 11, wherein the standard dimmer is a triac phase-cut dimmer.

15. Method of adjusting a base cap of a fluorescent lamp for enabling a fluorescent lamp to be dimmed with the aid of a standard dimmer, with less flickering than a conventional fluorescent lamp base cap, comprising connecting at least one resistor in parallel between input electrodes of a fluorescent lamp circuit, and on the base cap of a fluorescent lamp.

16. Method according to claim 15, wherein the standard dimmer is a triac phase-cut dimmer.

17. Method according to claim 15, wherein the resistor is a resin placed at least on the outside of the base cap, between the input electrodes of the fluorescent lamp circuit.

18. The base cap of claim 4, wherein the base cap further comprises a standard screw and/or bayonet base cap for lamps.

19. The base cap of claim 7, wherein the resistance of the resistor is approximately 22 kΩ.

20. The base cap of claim 8, wherein the capacitator has a value of at least 25 μF.
